(19) United States
(12) Patent Application Publication
(10) Pub. No.: US 2011/0275457 A1
(43) Pub. Date: Nov. 10, 2011

(54) ARENA FOR A BALL GAME

(75) Inventor: Stefan Roedel, Ebersburg (DE)

(73) Assignees: Stefan Roedel, Ebersburg (DE); Rudolf Roebig, Kuenzell (DE); Alfred Hahner, Kuenzell (DE)

(21) Appl. No.: 13/102,642

(22) Filed: May 6, 2011

(30) Foreign Application Priority Data
May 6, 2010 (DE) 102010019639.8

(51) Int. Cl. A63B 67/00; B23P 17/04

(52) U.S. Cl. 473/415; 29/428

(57) ABSTRACT

An arena, a process for manufacturing an arena and the use of an arena for a team ball game is described herein.

### TECHNICAL FIELD

An arena is described herein, and particularly, an arena for a team ball game, for example, soccer, ice hockey or handball. A process for manufacturing the arena and to a use of the arena for a team ball game is also described.

### BACKGROUND

Arenas for team ball games (also known as stadia) are well known in the state of the art. For example, a soccer stadium is a conventional arena for playing soccer games. Also known are arenas to be utilized exclusively for playing American football or rugby football. Typically, these arenas consist of a playing field localized centrally, which is, optionally, surrounded by running tracks or a respective activities-zone. Adjacent to the tracks are the spectator areas, constructed in the form of stands, whose shape usually follows the shape of the running tracks or the playing field.

There are some disadvantages, however, connected with conventional stadia. For example, many of them are constructed very spaciously, such that in a typical team ball game, only few opportunities arise to score a goal. In general, team ball games conducted in this kind of arena are characterized by a predominance of defensive tactics employed by the teams. Especially at the end of the game and in situations of a large difference in scores, this leads to an overall more defensive course of the game and a lackluster performance. Moreover, the arenas are constructed so as to limit the amount of freedom with respect to the rules governing the game. Arenas are usually installed permanently and are either only partly or not suited for general training purposes or for training the interaction efficiency within a team.

Some prior art documents tried to overcome the aforementioned deficiencies of conventional arenas.

DE 20 2007 009 204 U1 relates to an arena for a ball game, comprising a rectangular playing field surrounded by boundary side and end walls which can be incorporated into the game. The dimensions of the playing field are such that the length of the playing field equals 1.8 to 2.3 times its width. A goal is located on each short side of the rectangle, whereby the goals are formed within the end walls.

CA 2 471 428 A1 relates to a compact hockey arena, comprising a game box that includes a floor, side walls and end walls. Each wall end includes a goal formed therein. A center wall extends up from the center of the floor to divide the game box into a plurality of playing areas. The center wall includes one or more passages formed therein to allow a puck or a hockey ball to pass from one side of the center wall to the other.

U.S. Pat. No. 5,682,711 relates to a game field comprising a fixed dome structure and a pair of movable units each having an arena for playing a game thereon. The fixed structure comprises fixed amphitheater seats around a center void where a movable unit is located when in active position.

U.S. Pat. No. 4,781,385 relates to an arena for games whereby the playing field is surrounded by wall elements, for example side nettings.

### SUMMARY

An arena for team sports is described herein, which overcomes the problems and deficiencies associated with conventional arenas known from the state of the art. In particular, the arena provides for an exciting team ball game, which is action-packed by allowing for permanent scoring opportunities. Therefore, tactics employed by the players have to combine an appropriate mixture of both, offensive and defensive elements.

The arena is designed in such a way as to allow for a relatively simple set of gaming rules. Within the present arena, techniques of passing, shooting and defense, but also speed and team coordination can be practiced efficiently, such that the arena can be utilized for training efficient team play also for other ball games. By using the arena in the context of a ball game, cleverness, anticipation and coolness of the players can be trained.

The present disclosure relates to an arena, a process for manufacturing the arena and to a use of the arena for a team ball game.

In a first aspect, the arena for a team ball game comprises a playing field, at least on side wall and at least three goals. The basic shape of the playing field contains at least two axes of mirror symmetry and/or one axis of rotational symmetry. The at least one side wall delimits the playing field laterally and extend from the playing ground upwards in the vertical direction. The goals are formed as passages in the at least one side wall.

The playing field may comprise any area which is suitable for playing a team ball game. There are no limitations regarding the material from which the playing field is constructed, i.e. any material can be used. Exemplary materials are wood, stone, concrete, (resin-bonded) composite materials (e.g. particle board), asphalt, sand, grass or any multi-purpose turf. The material generally provides for good traction control during a game, thereby enabling the player to move with greater speed on the playing field. At the same time, the material can exhibit a hardness sufficiently small to protect the players from injuries due to falling. In some embodiments, the playing field should be planar and should exhibit neither depressions nor elevations, which would render the movement of the ball unpredictable for the players. Moreover, to enable free movement of both, players and the ball, on the playing field, the playing field should not contain any obstacles or respective sources of danger.

With respect to this aspect, it is important that the basic shape of the playing field comprises at least two axes of mirror symmetry and/or one axis of rotational symmetry.

The term “mirror symmetry” (or reflectional symmetry, line symmetry) refers to any form of symmetry of objects which are mirrored along an axis of symmetry. The term “rotational symmetry” (or radial symmetry) as used herein refers to any form of symmetry, whereby the rotation of an object by a certain angle with respect to a particular rotational axis superimposes the object onto itself. This rotational axis typically extends through the geometrical center of area of the playing field. An n-fold rotational symmetry means that rotation by an angle of 360°/n imposes the object onto itself.

The playing field can have the shape of an equilateral triangle, which comprises three axes of mirror symmetry and, in addition, a 3-fold rotational symmetry. Alternatively, the playing field can exhibit a rectangular shape with two axes of mirror symmetry and a 2-fold rotational symmetry. The playing field can have the shape of an equilateral polygon (n-gon) with n axes of mirror symmetry and an n-fold rotational symmetry. The axes of mirror symmetry can encompass the positions of the goals, the at least one side wall delimiting the playing field, and all further elements of the arena. The entire arena can comprise two axes of mirror symmetry and a 2-fold rotational symmetry.

The at least one side wall delimits the playing field laterally and extends from the playing field upwards in the vertical direction. The arena can comprise at least two side walls or at least four side walls, whereby the side walls are joined to each other in a flush arrangement. Thus, a ball can exit the arena laterally only by way of passing through one of the goals. There are no limitations regarding the material from which the at least one side wall is constructed. The material used, however, should possess a sufficient amount of rigidness, such that a ball is able to ricochet off the wall. Alternatively, it should be able at least to adsorb the kinetic energy of a ball. Accordingly, the side wall or side walls can be constructed from wood, stone, duroplastic material or other construction materials. The height of the at least one side wall delimiting the playing field can be selected such that a ball can be detained within the playing field with certainty. The height of the at least one side wall can be chosen to be at least 2.50 meters, or at least 3 meters. In some embodiments, the at least one side wall can be positioned in such a way that it exhibits, in conjunction with the playing area, the geometrical symmetries indicated above. In other words, the playing field and the at least one side wall can comprise jointly at least two axes of mirror symmetry and/or one axis of rotational symmetry.

Additionally, the arena comprises at least three goals, which are formed as passages in (i.e. through) the at least one side wall. In some embodiments, each side wall comprises only one goal or at most two goals, and these goals can be of the same size. The goals are delineated by two upright (i.e. vertical) posts, joined at the top by a horizontal crossbar. The dimension of the goals can be such that a spherical ball with a diameter of at least 20 cm, particularly of at least 30 cm, can pass through the goals. The distance between the goal posts can amount to about 3.20 meters. The horizontal crossbar can be localized at a distance of about 2.10 meters from the playing field. The goal posts and the horizontal crossbar can be round and can have a diameter of 8 cm. They can extend into the playing field by 3 cm, for example. There are no limitations regarding the materials, the goal posts and the horizontal crossbar may constructed from, as long as their stability is sufficient in the context of a ball game. Accordingly, the goal posts and the horizontal crossbar can be constructed from wood, plastic or metal. The goals can comprise nettings, which are able to detain a ball passing through the passages. The nettings can be attached to the goal posts, the horizontal crossbar and/or to the playing field. In some embodiments, the nettings may contain an integrated, re-sealable opening, allowing for a smooth exchange of players during a game.

Generally, the arena may comprise not more than 8 goals, as otherwise, spectators or players are prone to lose track of the game. In some embodiments, the arena therefore comprises four to eight goals, or exactly six goals.

The at least three goals can be positioned in the at least one side wall in such a way that they exhibit, in conjunction with the playing area and the at least one side wall, the geometrical symmetries indicated above. In other words, the playing field, the at least one side wall and the at least three goals can comprise jointly at least two axes of mirror symmetry and/or one axis of rotational symmetry.

If an area comprises the features indicated above, it can be used for a team ball game between at least three different teams, whereby it is optimized with respect to the speed of the game and strategic variability. An optimal strategy contains both, defensive and offensive elements, providing for permanent scoring opportunities in a typical course of the game. Due to its geometrical symmetry and the number of goals, the arena is suitable for practicing efficient team coordination also with respect to other kinds of ball games, thereby allowing for the development of mental strength of the players and training their anticipation skills.

In some embodiments, the arena additionally comprises at least one feed opening to deliver a ball into the arena. If an arena comprises at least one such feed opening, a new ball can be supplied to the arena without a significant loss of time after a ball has exited the arena by passing through one of the passages forming the goals. With respect to the size of the feed opening, its dimensions are complementary to the ball and vice versa, such that the ball to be used exhibits at most the size of the feed opening, thereby enabling the delivery of the ball via the feed opening into the arena.

The feed opening can be localized at a height of at least 2 meters, in particular at a height of at least 2.50 meters, such that the ball entering the arena contains sufficient kinetic energy and bounces off the playing field a number of times, thereby allowing for an interesting and dynamic game right from the start.

In some embodiments, the playing field is shaped as a tetragon or an octagon, whereby two opposite, parallel side walls each comprise one goal. Two different, opposite, parallel side walls each comprise two goals. The remaining side walls, if present, are without goals. In this case, the playing field comprises two axes of mirror symmetry and a 2-fold rotational symmetry. Due to the tetragonal or octagonal shape of the playing field, an interesting and varied game can be made, if, for instance, six individual players or six teams are competing with each other.

In some embodiments, the arena may be octagonally shaped. The four side walls, which do not comprise goals, are each provided with a feed opening for delivering a ball into the arena. In other words, in this case the said arena comprises four feed openings, by which a ball can be delivered alternatively into the arena. The one or more feed opening(s) can either comprise a number of balls stored in a magazine, ready to replace a ball having passed through a goal, or, alternatively, the arena can comprise additionally conveying means, suited for conveying a ball from the goal to the feed opening. In the latter case, only one single ball is necessary for playing a game; the first situation, however, provides for a technically simpler solution and is predicted to be less error-prone. The side wall(s) without goals can extend into the playing field by about 1 meter to 1.20 meters. The ball is bouncing off said side-walls without goals in an angle which is hard to predict by the players, necessitating heightened attention during the complete course of the game. In other words, the bouncing properties of the ball are varied in the arena by the presence of side walls without goals in such a way that, in comparison to an arena comprising four rectangular side walls, the game is more for spectators.

The goals can each comprise at least one sensor for detecting the passage of a ball through the respective goal. For instance, one goal or each one of the goals can comprise a light barrier for optical detection of the passage of a ball. Alternatively, the goal can comprise an RFID-detector for detection of a ball provided with an RFID chip. Advantageously, the RFID-detector allows for collection of further data aside from detecting the passage of a ball through the goal, such as the velocity of the ball or the identity of the ball. The thus gathered information can be transmitted to a game evaluation system of the arena or reported to a referee via an appropriate information delivery system.

In some embodiments, the arena may comprise at least two feed openings localized in at least two different side walls for delivering a ball into the arena. In this case, the arena additionally comprises a randomization means, whereby the random delivery of the ball via each respective feed opening can be activated. Thus, the players cannot predict by which feed opening the ball will be delivered to the arena, hence allowing for the integration into the game of additional exciting elements.

In some embodiments, the at least one side wall may be essentially constructed from a transparent material. For example, the at least one side wall can essentially be made from fracture-proof glass, Plexiglas or acrylic glass. Among these materials, Plexiglas is desired due to its good mechanical stability and its low costs. In particular and advantageously, Plexiglas is diaphanous to light in the wavelength range of 350 to 750 nm (i.e. visible light) without significant scatter. Additionally, Plexiglas generally exhibits superior resistance to such mechanical stresses (such as pressure, stretching and bending) as to occur typically on impact with a ball. Accordingly, spectators are easily able to follow the game during a tournament, while at the same time being protected from being struck by the ball. This is particularly important, if spectators or reporters wish to record the game utilizing recording equipment sensitive to shock, such as cameras or videocamera-recorders.

The at least one side wall delimiting the playing field can be constructed, in particular, from connectable modular panels. The types of connection are chosen to allow for easy assembling and dismantling of the arena also by laymen. In some embodiments, assembly and disassembly should not require tools. As an example, the side walls maybe joined to each other rigidly via flanges or pins.

The playing field can comprise a surface made from grass, artificial turf, snow or ice, or multi-purpose layering. These materials are desired with respect to the speed of the game and due to their superior durability and resilience characteristics.

In some aspects, the arena is movable (non-stationary); in other words, it can be assembled and dismantled easily, as it comprises several modular elements, such as the playing field, the at least one side wall and the at least three goals. Furthermore, the arena may be highly innovative with respect to its construction and design.

The arena may be used within enclosed spaces, in which case it is an indoor arena. Moreover, it may be used in the open, in which case it is an outdoor arena. In the latter case, the arena can be constructed from a material capable of withstanding well weather conditions including rain, snow, sun and wind, without being altered in its functionality.

In some embodiments, the arena may comprise one or more stand(s) for spectators outside of the area of the playing field, which may encompass, for example, seating and standing areas for spectators or reporters. The stands can rise gradually towards the periphery of the arena such that spectators more remotely from the playing field also can attend to the game with ease. For example, at least 50 or at least 100 or at least 200 spectators may be watching a game in the arena from the one or more stand(s) while being either seated or standing.

Additionally, the arena can include a roof structure, which confers several advantages. On the one hand, players on the playing field as well as spectators on the stands may be protected sufficiently from different weather such as wind, rain, sun or some other weather conditions. On the other hand, the ball may not exit the arena by passing directly above the at least one side wall. This is particularly the case in a situation whereby the at least one side wall and the roof structure are joined together in a flush arrangement. The roof structure may be constructed from a material able to withstand typical weather conditions for an extended period of time, for example several weeks. Additionally, the roof structure should be sufficiently rigid to tolerate the impact of a ball without being damaged.

For example, the roof structure may be constructed from the same material as the at least one side wall. In some embodiments, the at least one side wall as well as the roof structure are made from Plexiglas to allow for the passage of light, while at the same time protecting players and spectators from the impact of either rain or sun.

In a further implementation, the arena may be covered with a netting which is joined to the at least one side wall in a flush arrangement, whereby the netting is arranged such that the ball cannot exit the playing field by passing above the at least one side wall. Thus, the rules of a team ball game can be simplified such that rules, which cover situations wherein the ball is “out of play”, can be eliminated.

In a second aspect, a process of manufacturing an arena for a team ball game is described. The process of manufacturing comprises three steps as follows. In a first step, the process comprises providing the playing field and at least one side wall. In a second step, the process comprises the positioning of the at least one side wall in a vertical direction such that it delimits the playing field in the lateral direction and extends in the upward direction with respect to the playing field. In a third step, the process comprises the shaping of at least three passages within the at least one side wall to provide for goals suited for a team ball game.

Typically, the steps may be conducted in the aforementioned order. Alternatively, the third step may be conducted before implementing the first step or before implementing the second step. In other words, the at least one side wall to be provided in step 1 may be formed with passages to provide for goals suited for a team ball game. Alternatively, the passages may be shaped before positioning of the at least one side wall in a vertical direction. By switching the order of steps of the process of manufacturing the arena equivalent alternatives of the process may be generated which do not affect the technical features of the arena.

The individual elements of the arena, i.e. the playing field, the at least one side wall and the at least three goals can be constructed in a modular way to allow for simple assembly and disassembly of the arena. The individual elements may, for example, be combined into a portable arena set, which may be stored within an appropriate storage device, such as a portable trunk or bag.

In a third aspect, the use of the arena for a team ball game is described. Team ball games are games such as soccer, ice hockey, handball or variants thereof.

The term “team ball game” refers to any ball game between either several individual players or several teams. The ball game may be organized as a single event on a single day, or as a weekend cup, for example as US cap, if several teams compete for a US Championship, or can be organized as an regional or World Championship.

The game can accommodate all kinds of events, as the size of the teams (i.e. individual players or teams) and the number of teams (for example, three, four, five or six or more teams), may be varied.

These and other objects, as well as many of the intended advantages thereof will become more readily apparent when reference is made to the following description taken in conjunction with the accompanying drawings.

### DESCRIPTION OF DRAWINGS

FIG. 1 is a top view of an implementation of an arena (1).

FIG. 2 is a top view of different implementations of the arena (1) exhibiting different basic shapes of the playing fields (10.

FIG. 3 is a side perspective view of an arena (1).

FIG. 4 is a top view of an alternative implementation of the arena (1).

Like reference symbols in the various drawings indicate like elements.

In describing the arena, process for manufacturing the arena and use of the arena herein and as illustrated in the drawings, specific terminology will be resorted to for the sake of clarity. The arena, process for manufacturing the arena and use of the arena are not intended to be limited to the specific terms so selected and it is to be understood, that each specific term includes all technical equivalents which operate in a similar manner to achieve a similar purpose.

### DETAILED DESCRIPTION

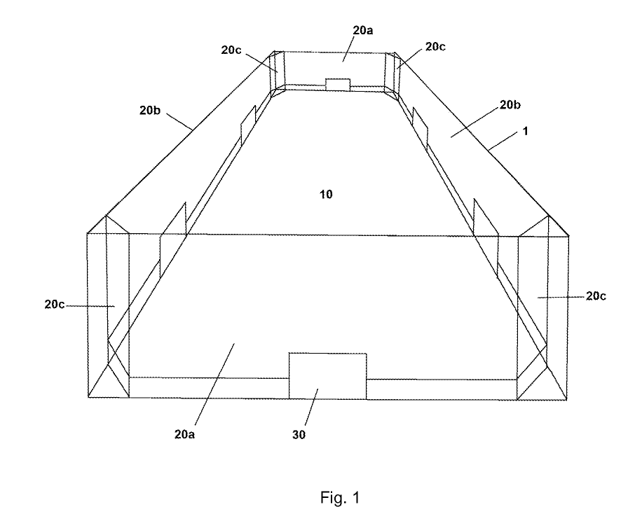

FIG. 1 is a top view of an implementation of the arena (1). In this example, the playing field (10) exhibits an octagonal shape and is delimited by a total of eight side walls (20a, 20b, 20c). The playing field (10) can be constructed from any material. In some embodiments, the playing field (10) is constructed with a conventional grass surface, a conventional ground floor or an artificial turf. The choice of material is likely to influence the speed of the game, i.e. on a conventional grass turf, players cannot move as fast as on conventional ground floor or artificial turf due to increased slip. On the other hand, the risk of injury is somewhat reduced with conventional grass turf, as a falling movement is absorbed more easily by the grass and its roots. The length of the playing field (10) along the midline is 41 meters. The width of the playing field (10) along the midline is 23 meters. Thus, the overall area of the playing filed (10) is about 942 square meters.

The playing field (10) can comprise different markings congruent with the rules governing the game. The midline can be indicated, for example, in parallel to the side walls (20b), or penalty areas, for which exists a special set of rules, can be marked accordingly.

The playing field (10) is delimited by the at least one side wall (20a, 20b, 20c). In the example, the side walls (20a) at both front ends are arranged in parallel. Equally, both of the longer side walls (20b) delimiting the playing field (10) along its longitudinal axis, are arranged in parallel. In addition, the arena comprises four side walls (20c) arranged so as to delimit the corners between side walls (20a) and side walls (20b). All side walls are joined to each other in an essentially flush arrangement such that the ball cannot exit the arena (1) but through the opening between the side walls (20a, 20b, 20c). All side walls (20a, 20b, 20c) extend from the playing field (10) upwards in the vertical direction. In the example, the side walls (20a, 20b, 20c) are constructed from Plexiglas enabling the spectators to follow the game also from the outside of the arena (1).

The side walls (20a, 20b, 20c) are formed with a total of six goals (30). The side walls (20a) at both front ends are each provided with a goal (30) localized at the center of the side wall (20a), whereby the geometrical dimensions of the goals (30) are such as to allow the passing of a ball with a diameter of at least 20 cm or at least 30 cm. Both of the side walls (20b) delimiting the playing field (10) along its longitudinal axis can each be provided with two similar goals (30), which are located with respect to each other and to the transitional area of side walls (20a) at approximately the same distance. The goals in the side walls (20b), for instance, are located at a distance of about 5 meters with respect to the center of the side wall (20b). Each of the goals (30) is of essentially the same shape, which is rectangular in this case, and size. For example, the width of each goal (30) is 3.20 meters. The height of each goal (30) is, for example, 2.10 meter.

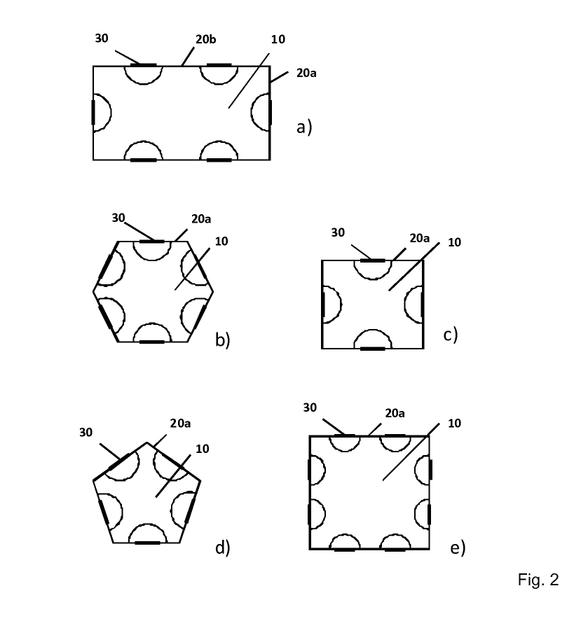

FIG. 2 is a top view of different implementations of the arena (1) exhibiting different basic shapes of the playing fields (10). FIG. 2a depicts an implementation of the arena (1) with a rectangular shaped playing field (10), four side walls (20a, 20b) and six goals (30). One goal (30) is localized in each of the side walls (20a) on the short sides of the rectangle. Two goals (30) are localized in each of the side walls (20b) on the long sides of the rectangle. The playing field (10) is rectangular and exhibits a 2-fold rotational symmetry and two axes of mirror symmetry. The axes of mirror symmetry encompass the positions of the six goals (30) and the side walls (20a, 20b) delimiting the playing field (10).

FIG. 2b depicts an alternative implementation of the arena (1) with a hexagonal shaped playing field (10), delimited by six equilateral side walls (20a) each provided with one goal (30). In this case, the playing field (10) exhibits a 6-fold rotational symmetry and additionally six axes of mirror symmetry, which intersect within center of the playing field (10) (in its geometrical center of gravity). The axes of mirror symmetry encompass the positions of the six goals (30) and the side walls (20a) delimiting the playing field (10).

FIG. 2c depicts a further alternative implementation of the arena (1) with a square shaped playing field (10). The playing field (10) is delimited by four equilateral side walls (20a) each provided with one goal (30) localized in the center. The playing field (10) exhibits a 4-fold rotational symmetry and additionally four axes of mirror symmetry, which intersect within center of the playing field (10) (in its geometrical center of gravity). The axes of mirror symmetry encompass the positions of the four goals (30) and the side walls (20a) delimiting the playing field (10).

FIG. 2d depicts a further alternative implementation of the arena (1) with a pentagonal shaped playing field (10). The playing field (10) is delimited by five equilateral side walls (20a) each provided with one goal (30) localized in the center. The playing field (10) exhibits a 5-fold rotational symmetry and additionally five axes of mirror symmetry, which intersect within center of the playing field (10) (in its geometrical center of gravity). The axes of mirror symmetry encompass the positions of the five goals (30) and the side walls (20a) delimiting the playing field (10).

FIG. 2e depicts a further alternative implementation of the arena (1) with a square shaped playing field (10). The playing field (10) is delimited by four equilateral side walls (20a) each provided with two goals (30). As exemplified in FIG. 2c, the playing field (10) exhibits a 4-fold rotational symmetry and additionally four axes of mirror symmetry, which intersect within the center of the playing field (10) (in its geometrical center of gravity). The axes of mirror symmetry encompass the positions of the eight goals (30) and the side walls (20a) delimiting the playing field (10).

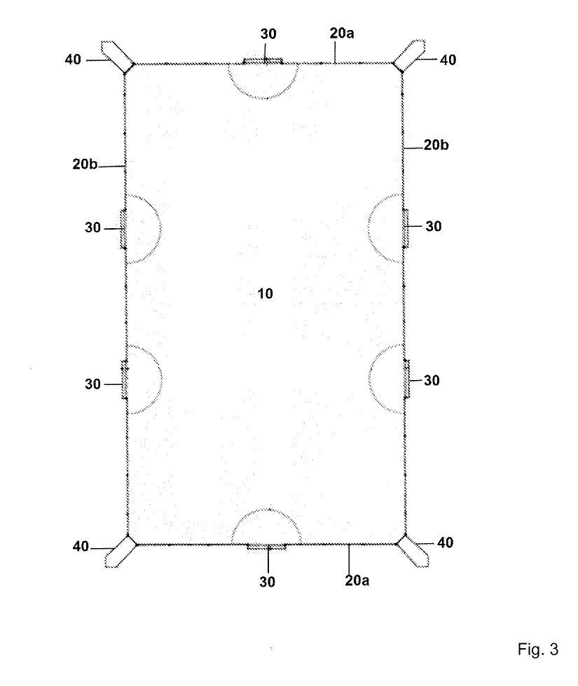

FIG. 3 is a side perspective view of an arena (1). In this implementation of the arena (1), the arena (1) comprises a playing field (10), eight side walls (20a, 20b) and six goals (30). One goal (30) is localized in each of the parallel side walls (20a) on the short sides. Two goals (30) are localized in each of the parallel side walls (20b) on the long sides. The shape of the playing field (10) is octagonal. The playing field (10) exhibits a 2-fold rotational symmetry and additionally two axes of mirror symmetry, whereby the axes of mirror symmetry encompass the positions of the six goals (30) and the side walls (20a, 20b) delimiting the playing field (10). Additionally, the arena (1) comprises four feed openings (40) to deliver a ball into the arena (1). The feed openings (40) are localized in the side walls (20c) provided without goals at a height of 2.50 meters. The axes of mirror symmetry also encompass the positions of the feed openings (40).

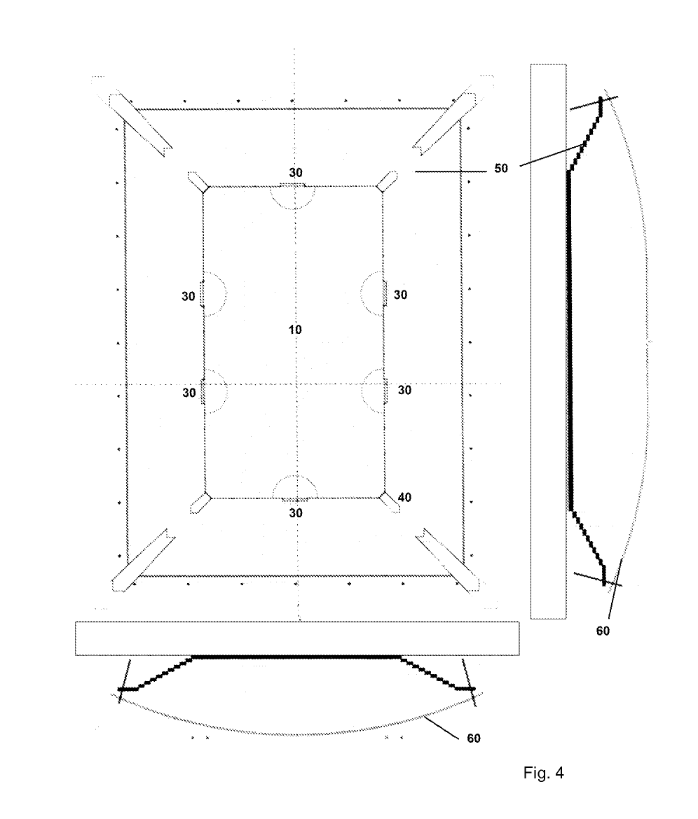

FIG. 4 is a top view of an alternative implementation of the arena (1). The area (1) comprises all features depicted in FIG. 3. Additionally, the arena comprises stands (50) for spectators oriented alongside the side walls (20a, 20b) and a roof construct (60) which is joined to the side walls (20a, 20b) in a flush arrangement.

The arena (1) advantageously provides for an interesting and exciting team ball game, whereby the spectators are presented with a multitude of scoring opportunities within a short time frame. Therefore, tactics employed by the players in general have to be variable, and contains, due to the geometrical dimensions of the playing field (10) and the design of the side walls (20a, 20b, 20c) and respective goals (30), an appropriate mixture of both, offensive and defensive elements.

### Use of the Arena

The arena (1) can be used as follows for a team ball game.

Rules are designed for players aged 16 to 40 years. For younger (<16 years) or older (>40 years) players the following modifications are allowed: the duration of the game can be shortened, the size of the playing field can be diminished, and the ball can be adapted accordingly regarding its size and weight. The game can be conducted by male as well as female players.

### Rule No. 1—the Arena

The arena utilized may be the arena described herein. In the chosen example, the playing field has an octagonal shape. The side walls provided with two goals are longer than the side walls with only one goal. The surface of the playing field can be constructed from material comprising conventional turf, conventional ground floor or artificial turf. The playing field measures about 40 to 42 meters in length, and about 22 to 24 meters in width. The playing field is delimited by side walls. In front of every goal, a semicircular area containing a penalty mark (penalty spot) is delineated by an appropriate marking.

The distance from the side wall to a goal post is 1.5 meters, to the goal line the distance is 3 meters. Within 6.5 meters measured from the center of the goal line (in between the goal posts) and equidistant from both posts, the penalty spot is indicated clearly visible by an appropriate marking. The diameter of the penalty spot is anywhere between 10 and 15 cm.

In each side of the playing field the corners are delimited by corner walls. These walls extend into the playing field by about 1.0 to 1.20 meters. The corner walls are provided with feed openings to deliver a ball into the arena, which are localized at a height of about 2.50 meters above ground.

The center of a side is located at the center of the respective sides. In the center of each short side, only one goal is present. The two goals present on each long side of the playing field are provided at a distance of about 5 meters from the center of the side, such that the distance between the outer goal posts measures 10 meters. The goals consist, for example, of two upright posts joined on top by a horizontal cross bar. The distance between the inner side edge of the goal posts measures 3.20 meters. The bottom edge of the horizontal cross bar is located at 2.10 meters above ground. Both the goal posts and the horizontal cross bar are round with a diameter of 8 cm. All goals are of similar format.

The width of the goal line between the goal posts in this example measures 8 cm. The goals are provided with nettings, which can be attached to the goal posts, the horizontal cross bar or the ground. The nettings can be provided with a suspension device in the rear of the goal such that a player can move within the goal. Additionally, the netting contains an integrated, re-sealable opening, allowing for a smooth exchange of players during a game.

The goal posts extend into the arena by about 3 cm and are fixed to the arena. In the case of damage to the arena or the goals during a game, functionality can be regained quickly by supplying appropriate replacement parts, in which case the game has to be interrupted for a short time. Goal posts are made from a material selected from the group of either wood or metal.

The horizontal crossbar also can be replaced quickly by original spare parts to enable quick restoration of functionality during a game. For exchange, or correction of the positioning of the horizontal cross bar, the game should be interrupted, if possible. After replacement or repair of the horizontal cross bar, the game is continued by delivering the ball to the arena via one of the feed openings.

In the case of a dysfunction of the lighting system or in the case of bad weather conditions, the game may be terminated 30 minutes after the interruption at the earliest. This also applies in the case of dysfunction of the arena construction. If the damage can be repaired within this time frame, the game is to be continued. Should a repair of the lighting system be only partially successful, the decision whether to continue or terminate the game will be made by the referee.

### Rule No. 2—the Ball

In the present example, the arena will be used in conjunction with a ball, which possesses the following cumulative characteristics: the ball is spherical, is made from leather or another appropriate material, and displays a circumference ranging from at least 68 cm to at most 70 cm. At the beginning of the game, the ball weighs at least 410 grams and at most 4500 grams with an interior pressure ranging from 0.6 to 1.1 atm, corresponding to 600 to 1.100 g/cm2 at sea level.

If the ball deflates or is damaged otherwise during the game, the game has to be interrupted for removing the ball from the playing field. A new ball will be delivered at random to the arena via the feed openings after continuation of the game indicated by an appropriate sign of the referee. In the case the damage occurs before a penalty kick, a kick off or a free kick, the ball will be replaced and the respective action will continue according to the appropriate rule. Replacement balls have to be examined by the referee before the game with respect to their suitability for a game. Furthermore, the referee has to examine all balls to be employed in a game before the game starts.

For players younger than 16 years, the circumference of the ball is adapted to a range from 63. 5 cm to 66 cm, and the weight of the ball is adjusted to a range from 350 g to 390 g.

### Rule No. 3—Number of Players

In the present example, there are six players, who all compete against each other. No teams are formed.

Alternatively, 6 teams can be formed, but also in this case, only individual players play against each other. Individual players can nevertheless be substituted quickly by the substitute players from their respective teams. Teams can comprise 2, 3 or 4 players. For official competitions, admissible team variants are agreed upon upfront.

It is inadmissible for teams to comprise different numbers of substitute players/team, e.g. team 1 with 3 substitute players and team 2 with 4 substitute players etc. Names of the players have to be communicated to the referee before the start of the game.

Substitute players have to remain outside of the playing field and outside of the goal (including the netting). Substitution takes place by way of an opening in the goal netting. The substitute player is only allowed to enter the opening in the netting after the player to be substituted has left the playing field via the opening. Disobediance of the rule will result in an appropriate measure to penalize the team and in the issuance of a warning to the player, who committed the offence. The warning is indicated by the issuance of a penalty card. In the case a player has been sent off the playing field, the game is continued only after the respective player has left the playing field.

Each team elects a team leader, who serves as a contact person for the referee. While the team leader assumes responsibility for the conduct of his or her team, he or she is not enjoying special privileges.

### Rule No. 4—the Referee

Each game is officiated by a referee, who has the authority to enforce the rules of the game in connection with the match to which he has been appointed.

The referee has to enforce the rules of the game; has to ensure that any ball used meets the requirements of rule No. 2; has to ensure that the players' equipment meets certain standards; has to keep record of the offences committed and the penalty measures issued; has to interrupt the game in case of major offences or injuries or to terminate the game for appropriate reasons; has to ensure that any player bleeding from a wound leaves the playing field and returns only after the bleeding has stopped; has to mark in a game without substitute players the respective goal of the player as void, and has to initiate the delivery<of a new ball via the feed openings in case a ball remains in the empty goal; has to ensure that no unauthorized persons enter the field of play, has to indicate the restart of the match after it has been stopped. The referee's decisions regarding facts connected with the game are final.

A referee cannot be held liable for: any kind of injury suffered by a player or spectator, any damage to property of any kind, any other loss suffered by any individual, club, company, association or other body, which is or may be due to any decision that he made under the terms of the laws of the game or in respect of the normal procedures required to hold, play and control a match. This can include, for example, a decision that the condition of the playing field or its surrounds or that the weather conditions are such as to allow or not to allow a game to take place. Furthermore, included are the following decisions made by a referee: a decision to abandon a match for whatever reason; a decision as to the condition of the fixtures or equipment used during a match including the goalposts, the horizontal crossbar and the ball; a decision to stop or not to stop a match due to spectator interference or any problem in the spectator area; a decision to stop or not to stop play to allow an injured player to be removed from the playing field for treatment; a decision to request or insist that an injured player be removed from the playing field of play for treatment; a decision to allow or not to allow a player to wear certain apparel or equipment; a decision (in so far as this may be his responsibility) to allow or not to allow any persons (including team or stadium officials, security officers, photographers or other media representatives) to be present in the vicinity of the playing field.

The referees usually wear a black uniform, but other colors can also be worn. Referees use a whistle, hand signs, verbal or other ways of communication to indicate an interruption or the commencement of a game, to address the players directly, or to indicate the starting of a penalty kick. A penalty kick can only be awarded if the offence was committed within the arena and the ball was in play.

The referee can interrupt the game due to weather conditions or any other related reasons. The game should not be interrupted for more than 30 minutes, albeit it is in the discretion of the referee to be more liberal if a rapid resumption is foreseeable after that time has passed. The game should be terminated only after all possible measures for a successful resumption have been employed.

In the case of an injury of a player, the referee ascertains by questioning the player if treatment is necessary. If the injured player wishes to be treated, the referee authorizes one or two team officials (paramedics or other authorized personal) to enter the playing field. In the case of teams playing, the injured payer is treated outside of the arena, except in the case of a very serious injury. In this situation, the substitute player will cover for the injured player immediately and the game will be resumed by delivering a ball into the arena via the feed openings employing a randomization device. The referee has to document the injury appropriately.

Each player is allowed to consume refreshments, e.g. in form of drinks; these have to be placed, however, outside of the arena (behind the netting of the goals) and cannot be brought onto the playing field. The Official Organizers of the game are responsible for the safety of the referee prior to, during and after the game (i.e. when leaving the arena).

The referee can issue disciplinary sanctions (warnings and penalty cards) against players and substitute players, after the players and the referee have entered the arena and the playing field to start or resume a game. This authority ceases when the referee is leaving the arena. The referee can allow the play to continue when the team against which an offence has been committed will benefit from such an advantage. If a team or player does not commence the game within 15 minutes from start, the team or player will be disqualified

### Rule No. 5—Duration of the Game

In the example, each player is credited with a scoring of 10 points at the beginning of the game (alternatively, and depending on the match, 5 or 7 points are awarded). After scoring a goal, a point is subtracted from the overall score of the player who scored the goal, while at the same time adding a point to the overall score of the player who received the goal. The winner of the game is the player or the team who first reaches an overall score of zero points. The subsequent ranks are determined according to the overall scores of the remaining teams. The case of a tie between the teams or players competing for second and third position, a shoot-out is conducted for the respective teams, which, additionally can be employed for determining the ranks of all participating teams or players.

In a shoot-out, the players have to strike from the goal area localized at a short side of the playing field at the goal localized at the opposite side. The ball has to be kicked high such that it comes off ground for at least part of the kick. Players do not kick simultaneously. The shoot-out is conducted until all ranks are determined unambiguously. If, for example, four players competing for second and third positions are tied with respect to scores, but subsequently, only three players score and on player misses, only the successful players will continue the shoot-out. If then, for example, only one of the remaining player scores and two players miss, that successful player will be awarded with the second position, while the two unsuccessful players will continue the shoot-out with respect to the third position. Again, if one of the two remaining players misses, while the other player scores, that scoring player will be awarded with the third position.

In the case that no winner can be determined after a duration of 75 min, the game will be terminated. Ranks will be assigned according to the respective overall scores of the teams or players. In a tie situation, shoot-outs can be conducted as well. The game will be interrupted for penalty kicks, in the case a player is injured, or in a situation where either the ball or the arena is dysfunctional. A game thus interrupted will be resumed keeping the scores prior to the interruption and accounting for the overall duration the game.

To enable a smooth and trouble free conduct of the game, all actions have to be conducted in a timely fashion, i.e. within 20 s in general. In the case of disobedience of this rule appropriate penalty measures will be applied (penalty card, addition of a penalty point to the overall score). The duration of the game is controlled by an Official. Maximal duration of a game for players aged>40 years is 60 min. For some other age groups, durations are as indicated in the following table

| | |
|---|---|
| 0-8 years | 25 minutes |
| 8-10 years | 30 minutes |
| 10-12 years | 35 minutes |
| 12-16 years | 45 minutes |

### Rule No. 6—Starting and Restarting a Game

Prior to starting the game, the referee determines number and presence of the players. A drawing method is used for assign goals to respective teams or players. At the start of the game, after an appropriate sound signal provided by the referee or a member of the organizing body, a ball is delivered into the arena via the feed openings employing a randomization device. At first, each player is within proximity of the assigned goal, respectively. After goal has been scored in the player's own goal, the player places the ball within the own goal and to continue the game. After a goal has been scored, it is not permitted to aim directly at the goal of the player who has scored the said goal.

### Rule No. 7—Ball in and Out of Play.

The ball is out of play when it has wholly left the arena. Should the ball be outside of the arena, a new ball is delivered into the arena via the feed openings employing a randomization device. This situation is entirely avoided in such cases where the arena is provided with a roof construction.

### Rule No. 8—Goalscoring

A goal is scored when the whole of the ball passes over the goal line, between the goalposts and under the crossbar, provided that no infringement of the laws of the game has been committed previously by the player or the team scoring the goal. The use of the whistle by the referee in case of a goal kick is not considered necessary, hence it should be used only in situations of uncertainty. In the case that the actual passing of the ball over the goal line is held in doubt, the referee is urged to continue the game. A goal scored is considered void, if the ball has been stopped before passing over the goal line by any kind of external influence. If such a situation occurs during a regular game (with the exception of a penalty kick), the game has to interrupted. Afterwards, a new ball has to be delivered into the arena via the feed openings.

### Rule No. 9—Misconduct and Unsporting Behaviour

Penalty kicks, points or cards are reward to a player committing the following offences with intention or at least by negligence, as decided by the referee: acts involving an opponent, such as reckless charging of an opponent or trying to charge an opponent (e.g. by kicking, jostling, hitting, pushing), holding an opponent, spitting at the opponent; other acts of misconduct such as touching the ball twice in direct succession, reckless behavior in general, preventing the movement of opponents; any other act of misconduct not enlisted herein in the course of which it is necessary to interrupt the game or to send the player off the playing field. The issuance of warnings to players is in the discretion of the referee.

In the case of overt recklessness and unsporting behavior the player can be sent off the playing field immediately. Exemplary offenses are: serous foul play, playing with excessive violence, spitting at an opponent or usage of offensive, scandalous or slanderous language or gestures.

Whenever a second penalty card is awarded to a player or team, the game is terminated for the respective player or team. Substitute players can be penalized as well with regard to the same offences, whereby the same penalty measures are available.

Independent of the position of the player inside or outside the arena, the punishment depends upon the actual nature of the offence committed by the said player. A punishable offence thereby could have been directed against any opponent, any fellow team player, the referee or any other person.

### Rule No. 10—Penalty Kick

A penalty kick is awarded according to the rules of the game. The ball has to be placed onto the penalty spot. The affected players have to conduct the penalty kick and have to guard the goal, respectively. Only in the case of an injury, substitute players are permitted to cover. The opponent player must remain in the appropriate goal at the goal line between the goal posts facing the other player until the ball has been touched by that other player, e.g. by foot. The other players have to remain in their respective goals until the ball has been touched. The player conducting the penalty kick has to move the ball forward by kicking with the foot.

If the player who conducts the penalty kick disobeys the rule, there are two possible situations: when no goal is scored, the game continues; when a goal is scored, however, the penalty kick is repeated. If the player who guards the goal disobeys the rule, there are two possible situations: when no goal is scored, the penalty kick is repeated; when a goal is scored, however, the goal is credited to the player. Any interference with the penalty kick by any player will be rewarded with a penalty measure to the respective player. Refusal of the offending player to occupy the goal will be rewarded with a penalty measure to said player. In case of repeated failure to comply, the player or the respective team will be disqualified from the game.

### Rule No. 11—Specific Rules

The ball can only be touched once. Should the ball be touched twice in succession by the same player, without being transferred to a different player in between, it is in the discretion of the referee to decide if the underlying act was committed unintentionally or with intention and in disobedience of the rules. The ball can be played anytime employing any part of the body. Guiding of the ball by hand, however, is not permitted, as the ball is only allowed to be moved by short touch. Likewise, keeping or retaining the ball, e.g. between the legs, is not permitted.

In the case of disobedience, e.g. if the ball is guided, kept or retained by an individual player, the respective player will be issued a penalty measure and a new ball will be provided via the feed openings as soon as the former ball has been expelled from the arena.

Scissor kicks and overhead kicks are allowed as long as they do not compromise the safety of other players, as is in the discretion of the referee to decide. The referee, evaluates if an act of endangering other players was committed unintentionally or with intention and in disobedience of the rules. In the latter case, misconduct is to be rewarded with an appropriate penalty measure. The game will be interrupted and a new ball will be delivered into the arena via the feed openings. Should the ball move back the goal after touch by a player assigned to that goal without being touched by an additional player, said player has to move to the goal line of said goal immediately. In the case of disobedience, the player closest to ball prior to the occurrence of the own-goal situation, will be awarded a penalty kick, the decision of which is in the discretion of the referee.

Once a player or a team has scored three goals, goals are switched between teams by clockwise rotation. In the case that a team or a player is disqualified from the game, the respective goal remains void. A ball behind the goal line of the empty goal, the ball is considered “out of game” and a new ball will be delivered into the arena via the feed openings.

What is claimed is:

1. An arena for playing a team ball game, comprising a playing field, at least one side wall and at least three goals,
wherein the playing field has a shape that comprises at least two axes of mirror symmetry and/or one axis of rotational symmetry,
wherein said at least one side wall delimits said playing field laterally and extends from said playing field upwards in the vertical direction, and
wherein said goals are formed as passages in the at least one side wall.

2. The arena according to claim 1, further comprising at least one feed opening for delivering a ball into said arena.

3. The arena according to claim 2, wherein at least two different feed openings for delivering a ball into the arena are located in at least two different side walls, and
wherein the arena further comprises a randomization means, whereby the random delivery of a ball through each respective feed opening into the arena can be activated.

4. The arena according to claim 1, wherein the playing field has a square shape or an octagonal shape, and
wherein said arena comprises two opposite, parallel side walls each provided with one goal and further comprises two other, opposite parallel side walls each provided with two goals.

5. The arena according to claim 4, wherein the playing field has an octagonal shape, and
wherein the four side walls lacking goals are each provided with a feed opening for delivering a ball into the arena.

6. The arena according to claim 1, wherein the goals are provided with sensors for detecting a goal.

7. The arena according to claim 6, wherein the sensors are light sensors.

8. The arena according to claim 1, wherein the at least one side wall is made of a transparent material.

9. The arena according to claim 8, wherein the transparent material is Plexiglas.

10. The arena according to claim 1, wherein the playing field comprises a surface made from grass, artificial turf, snow or ice, or comprises multi-purpose layering.

11. A process of manufacturing an arena, wherein said process comprises the steps of:
providing a playing field and at least one side wall;
positioning the at least one side wall in a vertical direction such that it delimits the playing field in the lateral direction and extends in the upward direction with respect to said playing field; and
providing at least three goals suited for a team ball game as passages in the at least one side wall.

12. The process according to claim 10, wherein the playing field has a shape that comprises at least two axes of mirror symmetry and/or one axis of rotational symmetry.

13. The process according to claim 10, further comprising providing at least one feed opening for delivering a ball into said arena.

14. The process according to claim 13, further comprising providing at least two different feed openings for delivering a ball into the arena in at least two different side walls, and
providing a randomization means, whereby the random delivery of a ball through each respective feed opening into the arena can be activated.

15. The process according to claim 10, wherein the playing field has a square shape or an octagonal shape, and
the process further comprising providing two opposite, parallel side walls in the arena with one goal and two other, opposite parallel side walls in the arena with two goals.

16. The process according to claim 15, wherein the playing field has an octagonal shape, and
the process further comprising providing the four side walls lacking goals in the arena with a feed opening for delivering a ball into the arena.

17. The process according to claim 10, further comprising providing the goals with sensor devices for detecting a goal.

18. The process according to claim 10, wherein the at least one side wall is made of a transparent material.

19. The process according to claim 10, wherein the playing field comprises a surface made from grass, artificial turf, snow or ice, or comprises multi-purpose layering.
